(19) United States
(12) Patent Application Publication
(10) Pub. No.: US 2014/0272011 A1
(43) Pub. Date: Sep. 18, 2014

(54) ENCAPSULATION COMPOSITIONS COMPRISING OF SPICES, HERBS, FRUIT, AND VEGETABLE POWDERS

(71) Applicant: MCCORMICK & COMPANY, INCORPORATED, Sparks, MD (US)

(72) Inventors: Dmitriy ZASYPKIN, Sparks, MD (US); Shriram PARANJPE, Sparks, MD (US); Michael REICK, Sparks, MD (US); Suzanne JOHNSON, Sparks, MD (US)

(73) Assignee: MCCORMICK & COMPANY, INCORPORATED, Sparks, MD (US)

(21) Appl. No.: 14/218,400

(22) Filed: Mar. 18, 2014

Related U.S. Application Data
(60) Provisional application No. 61/794,590, filed on Mar. 15, 2013.

(51) Int. Cl. A23L 1/22

(52) U.S. Cl. CPC A23L 1/22016
USPC 426/96

(57) ABSTRACT

A dense solid particulate encapsulation compositions comprising above 40% and up to 100% spices, herbs, fruit and vegetable powders in the encapsulating matrix are disclosed. The encapsulation of encapsulants including flavors, fragrances, medications, nutritional supplements, and vitamins, all in the range from 0.1% to 20% by weight of the encapsulation composition is described. Also disclosed is the process of making of the encapsulation compositions. The target applications of the encapsulated compositions are also described.

### BACKGROUND OF THE INVENTION

1. Field of the Invention

The present invention relates to encapsulation compositions in which an encapsulate is encapsulated in a solid matrix by a process known as melt extrusion. More particularly, the present invention relates to flavor encapsulation compositions in which a flavoring agent is encapsulated by melt extrusion in a glassy, amorphous, or in a viscoelastic solid dense matrix containing spices, herbs, fruit, and vegetable powders as a major part of the matrix. The flavoring agent can be inherently present in the extruded spices, herbs, fruit and vegetable powders or intentionally added to enhance functionality. Incorporation of spices, herbs, fruit, and vegetable powders in the matrix creates an active carrier protecting and modulating the flavor and functionality of the encapsulated flavors or other encapsulates. In addition, interactions between the matrix components and flavors can create unique new flavors. The present invention also relates to processes for preparing such compositions.

2. Discussion of the Background

The encapsulation of encapsulates is an area of active research. In particular, the encapsulation of encapsulates such as flavoring agents, fragrances, medications, pesticides, preservatives, vitamins and other dietary supplements is desired for a number of reasons. In the case of medications and pesticides, encapsulation may be desired to achieve controlled release of the medications or the pesticides. For vitamins and dietary supplements encapsulation may be carried out to protect the vitamins from air-oxidation and, thus, to extend shelf life of the vitamins. In the case of flavoring agents, the encapsulation may be carried out to place the flavorings in an easily metered form which will protect and enhance the flavorings and release them at a controllable event, such as the addition of water.

Many encapsulation processes are known to target a glassy state of the encapsulating matrix that serves as a flavor carrier. The advantages of retaining the glass form of the matrix include increased physical stability of the dense solid, reduced loss of incorporated volatiles, and reduction of deleterious intermolecular reactions and oxidation.

It is generally known to skilled practitioners in the field of flavor encapsulation that the current practical commercial processes leading to stable, dry flavors in the glassy state are limited in great part to spray drying and extrusion fixation. The former process requires emulsification or solubilization of the flavor in an aqueous carrier containing the encapsulating solids, followed by rapid drying in a high temperature, high velocity gas stream and collection as a low-density bulk solid. The resultant moisture of the encapsulated compositions is in the range 1%-4% assuring glassy state at the temperatures above 50° C.

While spray drying accounts for the majority of commercially encapsulated flavor materials, several limitations of the process are evident. Low molecular weight components of compounded or natural flavor mixtures generally exhibit high vapor pressures and are usually lost, react, or disproportionate during the process. The resultant encapsulated flavors are porous, powdery and difficult to handle. The final product, a dry, free flowing fine powder will release encapsulates rapidly upon hydration whether rapid release is desired or not. Incorporation of insoluble plant material such as herbs in a significant amount in the solubilized carrier often is not practical for the reason of swelling of the plant material in water, resulting to a high viscosity, clogging atomizing wheels or nozzles during spray drying, and poor encapsulation.

Some other encapsulation processes may include freeze drying, drum drying and tray drying. These processes have marginal significance due to a high processing cost and relatively poor protection of encapsulates, compared to spray drying and extrusion. The processes of drying are slow in the case of freeze and tray drying resulting in a weak glassy character generated by slow drying rather than quick cooling. Volatile flavor losses are very significant. Drum drying could be a fast process; however, loss of volatile components is very significant on the contact with a high temperature surface. The drying processes often generate highly porous materials where the encapsulants are exposed to oxygen. All the above processes require a milling step further weakening encapsulated flavors. Preparation step involves making slurry where spices and herbs will swell and form a viscous dispersion that is difficult to control and process. For all these reasons our primary focus is on melt extrusion. In particular, the focus is on melt extrusion generating solid dense particles providing effective encapsulation of actives and extended storage stability.

U.S. Pat. No. 3,922,354 describes an extrusion process for preparing an improved particulate flavoring composition having controlled flavor release characteristics wherein the flavoring agents are incorporated into a matrix comprising partially gelatinized cereal solids and additionally modified dextrins, corn starch, gum acacia, salt, mono-di glycerides. The flavoring composition does not include spices, herbs, fruit and vegetable powders, and is intended for simulation of spice particles using encapsulation of spice extracts and oleoresins.

U.S. Pat. No. 4,060,645 describes a process for the production of a dehydrated food product consisting of stocks, soups, seasonings, condiments, and sauces; extracts of vegetables, fruits and spices, plated on dextrin. The starting material may contain spices, aromas, colorants, fats, sugars, and salts. The process involves extrusion into a chamber at a sub-atmospheric pressure, leading to expansion of the product and an increased solubility. The process is not designed for encapsulation of an encapsulate into a glassy or a dense matrix.

U.S. Pat. No. 4,230,687 describes high molecular weight carriers such as proteins, starches and gums which are plasticized by addition of significant amounts of water in the presence of encapsulate and subjected to a high shear dispersing process. The rubbery or plastic matrix with encapsulate is then extruded, recovered, and dried to yield a stable product.

U.S. Pat. No. 4,232,047 describes an encapsulated product in the form of spice concentrates and simulated spices, comprising from 0.5% to about 40% of essential oils and oleoresins encapsulated in a matrix comprising of starches, flours, gums, and proteins. The patent does not describe spices, herbs, fruit and vegetable powders as a part of the encapsulation composition.

U.S. Pat. No. 5,846,580 describes a method for preparing a completely formulated ready to cook product mix in the glossy state. The mix is heated in an extruder with multiple heating zones and extruded with the required addition of water. The composition is cooled and may be cut at the exit from the extruder die. The method does not include drying of the material. The composition contains about 5% to 50%, preferably about 10% to 35% of an identifying component powder, for example, chicken, bean, tomato, and the like. In addition, 5% to 20% of vegetable powders may be used. The composition made by the process may include 1 to 10% spices or spice extracts, however, explicitly excludes encapsulation of flavors and other actives.

U.S. Pat. No. 6,090,419 describes salt compositions and extrusion as a method of preparation. The composition could be glassy with inclusion of salt crystals and may contain, as a binder for salt, dried herbs and spices, ground/granulated onion/garlic, dehydrated peppers, and ground basil. The patent does not describe spices, herbs, fruit, and vegetable powders as a part of an encapsulation composition. The described encapsulates in the salt compositions do not include vitamins, medications and dietary supplements. The described process does not describe drying the compositions or die-face cutting followed by drying the particles.

U.S. patent application Ser. No. 13/087,732 describes melt extrusion encapsulation of flavors and other encapsulates in a glassy carrier containing spices and herbs. The composition comprises 5% to 40% of at least one spice or herb with the balance made up with low and high molecular weight carbohydrates or hydrolyzed gelatin. The composition does not include fruit or vegetable powders and does not describe compositions containing above 40% and up to 100% herbs, spices, fruit, and vegetable powders.

An article entitled: “Flow Characterization of Peach Products during Extrusion” (Akdogan, H. and McHugh, T. H., J. Food Sci., April 2000, Vol. 65, Issue 3, pp. 471-475) describes extrusion of drum-dried peach purees. The process did not lead to glassy encapsulation compositions.

An article entitled: “Influence of Extrusion Processing on Procyanidin Composition and Total Anthocyanin Contents of Blueberry Pomace” (Khanal, R. C. et al., J. Food Sci., March 2009, Vol. 74, Issue 2, pp. H52-H58) describes extrusion of 30% blueberry juice processing by-products and 70% sorghum flour. The described composition was not a glassy, amorphous, or dense solid encapsulation composition containing more than 40% of herbs, spices, fruit or vegetable powders.

An article entitled: “Impact of ripening stages of banana flour on the quality of extruded products” (Gamlath, S., Int. J. Food Sci. Technol., September 2008, Vol. 43, Issue 9, pp. 1541-1548) describes extrusion of 40% banana flour in combination with 60% rice flour. The described composition was not a glassy, amorphous, or dense solid encapsulation composition containing more than 40% of herbs, spices, fruit or vegetable powders.

In a number of cited patents which disclose melt extrusion, the matrix compositions were carefully defined to accommodate processing limitations of the extruder as well as to generate a stable matrix in the glassy state and characterized by a glass transition temperature of greater than 35° C. The cited patents describe liquid flavor, essential oils, oleoresins, processed flavors, medications, pesticides, and vitamins as encapsulates. However, the dense solid extrusion encapsulation compositions containing above 40% and up to 100% herbs, spices, fruit and vegetable powders have not been described.

Spices and herbs in their original and ground powdered form possess unique flavor properties. More recently it has been recognized that spices and herbs contain potent antioxidants that may have protective properties for oils and flavors. The same antioxidants may be health beneficial. Thus, there remains a need for encapsulation compositions in which an encapsulate is encapsulated in an active carrier which is stable in the glassy state at ambient or slightly elevated temperatures and contains a significant amount of spices and herbs in addition to liquid or solid encapsulates. These active carriers can exhibit unique flavor interactions with encapsulates and modulate a flavor imparted by encapsulates. In turn, flavors may modulate flavor characteristics imparted by the active carrier and have an effect on bioavailability or other antioxidant or protective functions of spices and herbs. There is also a need to mask, modify or mitigate some of the intense background notes introduced by either spices, herbs or encapsulates. The glassy carriers can preserve, modulate and control release of encapsulates. There is also a need to preserve labile and sensitive flavors with natural antioxidants introduced by spices, herbs, fruit and vegetable powders constituting a significant part of the active carrier.

Formation of a matrix as a dense amorphous or a glassy solid is of particular value for encapsulation of volatile oil-soluble and water-soluble flavors and extracts.

### SUMMARY OF THE INVENTION

Accordingly, it is one object of the present invention to provide novel encapsulation compositions.

It is another object of the present invention to provide novel encapsulation compositions in which an encapsulate is encapsulated in a carrier which is stable as an amorphous dense solid.

It is another object of the present invention to provide novel encapsulation compositions in which an encapsulate is encapsulated in a carrier which is stable in the glassy state at ambient temperatures.

It is another object of the present invention to provide novel encapsulation compositions in which an encapsulate is encapsulated in a carrier which is stable in the glassy state at ambient temperatures and contains spices, herbs, vegetable and fruit powders as a major part of the carrier composition.

It is another object of the present invention to provide novel flavor encapsulation compositions in which a flavor is encapsulated in a carrier which is stable in the glassy state at ambient temperatures and contains spices, herbs, vegetable and fruit powders as a major part of the carrier composition.

It is another object of the present invention to provide novel flavor encapsulation compositions which are amenable to the encapsulation of volatile or sensitive flavor components and containing spices, herbs, vegetable and fruit powders as a major part of the carrier composition.

It is another object of the present invention to provide novel flavor encapsulation compositions which exhibit desired controlled release functionality in product applications.

It is another object of the present invention to provide novel flavor encapsulation compositions which exhibit unique flavor, flavor delivery, antioxidant functionality and health benefits in product applications.

It is another object of the present invention to provide novel processes for preparing such encapsulation compositions.

These and other objects, which will become apparent during the following detailed description, have been achieved by the inventor's discovery that it is possible to prepare non-porous, dense amorphous or glassy solid carriers that contain above 40% and up to 100% spices, herbs, vegetable and fruit powders, and have sufficiently high Tg to prevent plastic flow and caking at ambient temperatures, by blending spices, herbs, vegetable and fruit powders, and one or more food polymers with an aqueous plasticizer in the melting zone of an extruder, adding the encapsulate to the molten matrix, and extruding the resulting mixture. The inventors also discovered that it is possible to prepare non-porous, dense amorphous or glassy solid matrices that contain 100% spices, herbs, vegetable and fruit powders, and have sufficiently high Tg to prevent plastic flow and caking at ambient temperatures, by blending spices, herbs, vegetable and fruit powders with an aqueous plasticizer in the melting zone of an extruder, adding the encapsulate to the molten matrix, and extruding the resulting mixture. The inventors also discovered that in some cases, when there is a sufficient amount of water in the matrix components, the direct addition of a plasticizer to the blends is not required.

Thus, the present invention provides:

A solid particulate extrusion encapsulation composition, comprising:

(A) an encapsulate, encapsulated in (B) a solid dense matrix comprising one or more matrix components, and one or more plasticizers;

wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein the encapsulate (A) is present in the extrusion encapsulation composition in an amount of from 0.1% to 20% by weight, based on the total weight of the extrusion encapsulation composition;

wherein said extrusion encapsulation composition is prepared by a process comprising:

(i) mixing the matrix components of the dense matrix (B), the encapsulate (A), and the plasticizer, thereby obtaining a blend;

(ii) in at least one extruder melting the blend, dispersing the encapsulate in the melted blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition, wherein said encapsulate (A) is encapsulated in the glassy matrix (B),

(iv) optionally drying the extruded encapsulation composition, and

(v) further cooling the encapsulation composition.

### DETAILED DESCRIPTION OF THE PREFERRED EMBODIMENTS

As noted above, the present invention has been made possible in part, by the inventor's discovery that it is possible to prepare, by extrusion, dense amorphous or glassy solid matrices which contain above 40% and up to 100% spices, herbs, fruit, and vegetable powders in a combination with 0% to about 60% of selected food polymers and 0% to 40% low molecular weight sugars and polyols, based on the weight of the matrix ingredients. Dense solid compositions have a non-porous structure with a specific gravity above 1.2 g/ml, more preferably above 1.3 g/ml. The inventors also demonstrated that it is possible to prepare glassy compositions using some of the spices, herbs, fruit, and vegetable powders. This discovery is a surprising result considering limited solubility, high molecular weight and, respectively, high viscosity of some of the spices, herbs, fruit and vegetable powders. The inventors discovered that many spices, herbs, fruit and vegetable powders can be thermoplastic at the specified temperatures and levels of plasticizers. In other words, the components can be melted and transformed into a fluid melt that could be shaped and extruded. Most surprisingly, the inventors discovered that the composition could include spices, herbs, fruit, and vegetable powders in the amount in the matrix, which constitutes a continuous phase of the melted compositions.

Thus, in a first embodiment, the present invention provides a solid, dense, particulate extrusion encapsulation composition, comprising:

(A) an encapsulate, encapsulated in (B) a solid dense matrix comprising one or more matrix components, and one or more plasticizers;

wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein the encapsulate (A) is present in the extrusion encapsulation composition in an amount of from 0.1% to 20% by weight, based on the total weight of the extrusion encapsulation composition;

wherein said extrusion encapsulation composition is prepared by a process comprising:

(i) mixing the matrix components of the dense matrix (B), the encapsulate (A), and the plasticizer, thereby obtaining a blend;

(ii) in at least one extruder melting the blend, dispersing the encapsulate in the melted blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition, wherein said encapsulate (A) is encapsulated in the glassy matrix (B),

(iv) optionally drying the extruded encapsulation composition, and

(v) further cooling the encapsulation composition.

In one preferred embodiment the solid dense extrusion encapsulation composition is in a glassy state with a glass transition temperature above 35° C., contains less than 10% water and an encapsulate (A) in the range from 0.1% to 20% by weight, based on the total weight of the glassy extrusion encapsulation composition. Water content below 10% can be achieved in two different ways, depending on the composition. In some encapsulation compositions, water added at a level up to 30%, the compositions are extruded and then dried, cooled, and milled. Alternatively, water as a plasticizer is added in an amount below 10%, and then the encapsulation composition is extruded, die-face cut with a cutter, then dried, and cooled to ambient temperature.

In one preferred embodiment, the matrix composition (a) comprises 60 to 90% by weight, based on the total weight of said matrix (B), of a spice, an herb, a fruit powder, a vegetable powder, or a combination thereof.

In yet another preferred embodiment the matrix composition (a) comprises 90 to 100% by weight, based on the total weight of said matrix (B), of a spice, an herb, a fruit powder, a vegetable powder, or a combination thereof.

In yet another embodiment the composition does not contain any added flavor. In this case the encapsulated are the flavor components inherently present in a spice, an herb, a fruit powder, a vegetable powder.

In yet another preferred embodiment there is no plasticizer that is directly added to the matrix components. The matrix components typically contain some level of moisture. In this embodiment the amount of this water is sufficient to plasticize and melt the components.

In one embodiment the inventors demonstrated that particles can be prepared by die-face cutting in a wide range of specified sizes, from 0.1 mm to 7 mm depending on the die used in the extrusion process. Particles could be spherical, nearly spherical, half-spheres, rods, or flake-shaped at the other extreme of the spectrum. Depending on the shape of the die holes and the speed of the cutter the particles could have a variety of shapes and aspect ratios, including ones mimicking letters, logos, and familiar food shapes. More preferred target particle sizes are in the range between 0.5 mm and 3.0 mm. Particle size and shape have an effect on flavor release, caking, and flavor stability.

The described die-face cutting can assure a narrow particle size and shape distribution. In one preferred embodiment the width of the distribution is such that 90% of the particles by weight do not deviate in size from the mean value by more than 50% of the mean value. In another embodiment 90% of the particles by weight do not deviate in size from the mean value by more than 30% of the mean value. In yet another embodiment 90% of the particles by weight do not deviate in size from the mean value by more than 20% of the mean value. For example, in the latter embodiment if the mean particle size is 500 microns then 90% of the particles by weight would have a size between 400 and 600 microns. If the shape of the particles is not spherical then the same specification may be applied to each characteristic dimension of the particles. For example, if the particles are cylindrical rods then 20% deviation is applied to each characteristic dimension, namely, to the length of the rods as well as to their diameter.

The particle size and shape distribution may be measured or evaluated in a number of ways known in the art, including but not limited to the following methods: direct measurement with a caliper, sieve analysis, light scattering methods, microscopy, optical projection methods accompanied with image analysis. The particle size distribution may be defined as a distribution of particles by their size, surface area, weight, volume, color, or any other characteristic of interest.

Clean and robust die-face cutting is important to provide a narrow particle size and shape distribution when it is important in target applications. The inventors have surprisingly discovered that stickiness and excessive fluidity of encapsulation compositions containing spices, herbs, fruit and vegetable powders can be controlled with the right balance of the encapsulation composition and by additional cooling of the melt in an extruder prior to die-face cutting. A cooling jacket of a cooling zone of an extruder has been demonstrated to be important to control cutting of such encapsulation compositions.

A number of components added to the matrix (B) could help reduce stickiness of the melt during die-face cutting. These anti-sticking components could include but not limited to calcium, magnesium, sodium, or potassium salt of a fatty acid; mono-di-glycerides; silicon or titanium dioxide; propylene glycol monostearate; a lecithin, and saturated fats. Some starches, modified starches, and gums including xanthan gum, agar-agar, carrageenan, alginate, cellulose derivatives, and edible fibers could also assist in preventing stickiness of strands of a melted encapsulation composition during cutting.

In one embodiment a low level of an encapsulate or encapsulates is present on the surface of particles. The inventors discovered that it is possible to minimize surface flavor down to less than 1% based on the total weight of the flavor in the encapsulation composition. The surface flavor needs to be minimized in some applications to prevent oxidation, loss, or other flavor degradation.

A number of ways have been found to minimize the surface flavor. The inventors discovered that die-face cutting of the hot melt creates hot surfaces which volatile flavors are evaporated from. Even though some part of a volatile flavor could be lost in this way, the resulting surface flavor is low. This helps protect flavor integrity in the final encapsulation composition and is applicable to many volatile encapsulants. Greater emulsifying capacity of the encapsulating matrix was also found important in reduction of surface flavors. Finally, cooling the melt in an extruder prior to cutting and cutting larger particles are also important factors in satisfying the requirement of low levels of encapsulants on the surface of particles. The surface flavor may be measured by a solvent extraction of the particles followed by GC analysis.

In yet another embodiment the inventors demonstrated that interactions of encapsulants, especially encapsulated oils and flavors, with the matrix components in the extrusion process can generate unique new flavors.

The modified starches consist of a group of n-octenylsuccinic anhydride modified starches (OSAN-starch).

Maltodextrins are also suitable carbohydrate food polymers. The maltodextrins are defined as having a Dextrose Equivalent (DE) of less or equal 20. The most suitable maltodextrins are the 5 DE, 10 DE, 15 DE and 18 DE maltodextrins.

Hydrogenated starch hydrolyzates (HSH) are the products obtained from the hydrolysis of a starch to generate maltodextrin oligomers.

Polydextrose is the glucosyl homopolymer resulting from the condensation of glucose in the presence of an acidic catalyst. Polydextrose is included in the group of low molecular weight sugars.

Hydrolyzed gelatin is produced by hydrolysis of a gelatin. Gelatin, the soluble protein extract from collagen. The particular gelatins which are most compatible with the extrusion encapsulation process of the present invention are the 50 to 75 Bloom gelatins of both type A and B. Hydrolyzed gelatins are preferred in this invention.

Gum arabic is an exudate gum obtained from Acacia trees. The main species are Acacia senegal and Acacia seyal.

Larch gum or arabinogalactan is the hydrocolloid extracted from the Larch tree.

The present composition contains as a powder above 40% and up to 100%, preferably above 50% and up to 100%, based on the total weight of the matrix composition, of spices and herbs including those disclosed in: Herbs, Spices and Flavorings, 1982, Tom Stobart, The Overlook Press, Woodstock, N.Y., Wiley, New York, 320 p.; The Encyclopedia of Herbs, Spices, and Flavorings, 1992, Contr. Ed. E. L. Ortiz, Dorling Kindersley, Inc., New York, 288 p., both of which are incorporated herein by reference. Suitable spices and herbs include ajowan, alexanders, allspice, almond, aloe, angelica, anise, anise-pepper, annatto, areca nut, asafoetida, avens, balm, sweet basil, bay, bergamot, borage, calamint, chamomile, candlenut, caper, caraway, cardamom, catmint, celery, garden chervil, chicory, chive, cinnamon, cassia, citron, clary, clove, coconut, coffee, cola, coriander, costmary, cress, cumin, curry leaf, dill, fennel, fenugreek, galangal, garlic, garlic mustard, ginger, grains of paradise, hop, hyssop, juniper, leek, lemon grass, liquorice, lovage, mace, malt, marjoram, mint, dried edible mushrooms, mustard, nutmeg, onion, oregano, parsley, pepper, poppy, rosemary, saffron, sage, samphire, sesame, star anise, tarragon, thyme, turmeric, vanilla.

Spices and herbs are preferably blended as a dry powder. Spices and herbs are typically sterilized then dried to moisture in the range from 1% to about 12% by weight. The most preferred moisture of spices and herbs for the process of this invention is in the range from 2% to 7% by weight. Usually, dried spices and herbs are reduced in size by milling and/or sieving to sizes most suitable for applications. For the process of this invention the preferred size of the dry particles of milled spices and herbs is in the range from 20 microns to about 2 millimeters, even more preferred range is from 50 um to 1 mm, the most preferred range is from 70 um to 500 um.

It is also within the scope of the present invention that spices and herbs are additionally processed before melt extrusion. Besides mentioned above sterilization, drying, milling, and sieving, spices and herbs could be heated, roasted, blended, or treated with a solvent which is subsequently removed. Some actives or extractives could be removed from spices and herbs by a solvent extraction. Some specific parts of spices and herbs could be used instead of whole spices and herbs in their original or a processed form. These parts could be additionally processed as described above.

The present composition also contains 0 to 50%, 5 to 40%, preferably 10 to 35% by weight, based on the total weight of the matrix composition, of a component selected from the group consisting of a low molecular weight sugar, a low molecular weight polyol, a corn syrup solid, and mixtures thereof. Examples of suitable sugars include mono- and disaccharides (including glucose, sucrose, maltose, fructose, galactose, ribose, xylose, lactose, cellobiose, trehalose), invert syrups, molasses, and corn syrups. The preferred sugars are glucose, trehalose, sucrose, and maltose.

Polydextrose is the glucosyl homopolymer resulting from the condensation of glucose in the presence of an acidic catalyst.

Polyols are a group of lower molecular weight ingredients known as polyhydric alcohols. Simpler polyols include glycerine, and propylene glycol. Examples of other polyols include erythritol, lactitol, mannitol, sorbitol, maltitol, isomalt, dulcitol, xylitol, hydrogenated corn syrups, hydrogenated glucose syrups, hydrogenated maltose syrups, and hydrogenated lactose syrups. The preferred polyols are mannitol, sorbitol, and isomalt. Suitable corn syrup solids are the 36 to 42 D.E. corn syrup solids. Hydrogenated starch hydrolyzates (HSH) are the products obtained from the hydrolysis of a starch to generate maltodextrin oligomers.

The term encapsulate as used in the present invention, includes agents such as medications, pesticides, preservatives, vitamins, food acids, salts, flavors, perfumery chemicals and fragrances, and food colorants both synthetic and natural.

The term flavor includes spice oleoresins and oils derived from allspice, basil, capsicum, cinnamon, cloves, cumin, dill, garlic, marjoram, nutmeg, paprika, black pepper, rosemary and turmeric; essential oils: anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavors: garlic, leek, chive, and onion; botanical extracts: arnica flower extract, chamomile flower extract, hops extract, and marigold extract; botanical flavor extracts: blackberry, chicory root, cocoa, coffee, kola, licorice root, rose hips, sassaparilla root, sassafras bark, tamarind and vanilla extracts; protein hydrolysates: hydrolyzed vegetable protein (HVPs), meat protein hydrolysates, milk protein hydrolysates; and compounded flavors both natural and artificial including those disclosed in S. Heath, Source Book of Flavors, Avi Publishing Co. Westport, Conn., pp. 149-277, 1981, which is incorporated herein by reference. The flavoring agent may be in the form of oil, aqueous solution, non-aqueous solution or an emulsion. Flavor essences, i.e., the water-soluble fraction derived from fruit or citrus can be utilized. The present invention is particularly advantageous when a flavor is itself a combination of volatile compounds with varying vapor pressures.

Although the exact amount of encapsulate encapsulated in the matrix will depend, in part, upon the precise nature of the matrix, and the anticipated end use of final composition, the encapsulation compositions of the present invention will typically comprise 1 to 15% by weight, based on the total weight of the composition, of encapsulate. Preferably, the present encapsulation composition will comprise 6 to 10% by weight, based on the total weight of the composition, of encapsulate. The preferred encapsulate is a flavor.

When the encapsulate is a lipophilic flavor, the encapsulate is dispersed in the dense solid matrix of the final product usually with the aid of an emulsifier added to the lipophilic phase or in the matrix mature. Preferred emulsifiers are the sorbitan polyoxyethylene monoesters.

In addition to the foregoing encapsulates, various optional ingredients such as conventionally used in the art, may be included in the compositions of the present invention. For example, colorings, sweeteners, food acids, salts, fragrances, diluents, flavor maskers, flavor enhancers, fillers, preservatives, antioxidants, stabilizers, lubricants, and the like may be employed herein if desired.

The present encapsulation compositions are prepared by melt extrusion at the moisture of the melt and the product below 30%, more preferably between 4% and 20%, depending on the composition. Extrusion of spices, herbs, fruit and vegetable powders in the presence of 10% or higher moisture in the melt requires additional drying to form a glassy extrudate. The present inventors discovered that it was possible to prepare a glassy stable extruded composition at the moisture of the melt and the final product below 10%, preferably, between 4 and 8% by weight of the total composition. The glass transition temperature of the composition is above room temperature and preferably in the range between 35 and 55° C.

The present invention provides a method of making a solid dense particulate extrusion encapsulation composition, comprising:

(A) an encapsulate, encapsulated in (B) a solid dense matrix comprising one or more matrix components, and one or more plasticizers;

wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein the encapsulate (A) is present in the extrusion encapsulation composition in an amount of from 0.1% to 20% by weight, based on the total weight of the extrusion encapsulation composition;

said method comprising:

(i) mixing the matrix components of the dense matrix (B), the encapsulate (A), and the plasticizer, thereby obtaining a blend;

(ii) in at least one extruder melting the blend, dispersing the encapsulate in the melted blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition, wherein said encapsulate (A) is encapsulated in the dense matrix (B),

(iv) optionally drying the extruded encapsulation composition, and

(v) further cooling the encapsulation composition.

In the present process, the liquid plasticizer may be any which is suitable for facilitating the formation of the melt in the extruder while at the same time affording a product which exists in the dense solid amorphous or the glassy state. Solid state at room temperature can be for some compositions a viscoelastic state, also known as plastic or rubbery state. Suitable plasticizers include water; glycerol; propylene glycol; aqueous solutions of glycerol, propylene glycol, monosaccharides, and disaccharides; and corn syrups. In one preferred embodiment, the present composition is prepared by utilizing water as the liquid plasticizer.

The plasticizer is added in an amount which results in the formation of a melt in the extruder, while at the same time affording a product which exists in the solid viscoelastic or the glassy state at room temperature. Thus, the amount of the plasticizer added may be selected to afford a product which has a Tg of at least 30° C., preferably at least 35° C., more preferably at least 40° C.

Suitable carbohydrates which are utilized as the non-polymeric component in the formulas and which function in a concomitant fashion as a plasticizer include mono- and disaccharides including trehalose and sucrose, invert syrups, molasses, corn syrups, and 24 to 42 D.E. corn syrup solids. Suitable polyols are erythritol, sorbitol, mannitol, lactitol, maltitol, isomalt, dulcitol, xylitol, hydrogenated corn syrups, hydrogenated glucose syrups, hydrogenated maltose syrups, and hydrogenated lactose syrups. The preferred carbohydrates are glucose and maltose, and the preferred polyols are mannitol, sorbitol, and isomalt.

The matrix (B), along with the plasticizer forms a melt in the extruder. Although the mixing action of the extruder will supply heat to the matrix/plasticizer mixture, it will typically be necessary to supply additional heat to ensure formation of the melt. The encapsulate (A) is continuously added in a liquid phase to the feeding zone of the extruder by injection and mixed with the melted matrix/plasticizer mixture before exiting the extruder. In some embodiments, it may be preferred to add a non-aqueous, liquid plasticizer to the encapsulate phase.

In certain embodiments, a surface-active agent, i.e., an emulsifier can be added to the dry blend, or preferably added to the liquid flavor mix which is ultimately injected into the melting zone of the extruder.

In a preferred embodiment, a 2″ extruder assembly equipped with heating and cooling jackets, a die, and a cutter is used.

When the encapsulation composition exits the extruder, it may be cut with a cutter and cooled in ambient temperature air, or in chilled or sub-ambient temperature air, or by passing through a liquid bath filled with a non-solubilizing fluid, for example, an alcohol or an oil, with or without temperature control. Alternatively, strands of the extruded viscous dispersion may be cooled and further processed by size reduction, for example by grinding, milling or pulverizing. The product may also be treated with an anti-caking compound either before or after size reduction.

Other features of the invention will become apparent in the course of the following descriptions of exemplary embodiments which are given for illustration of the invention and are not intended to be limiting thereof.

### EXAMPLES

### Extrusion

Melt extrusion was accomplished utilizing a 2″ extrusion assembly equipped with heating/cooling jackets, fitted with a liquid injection port in the feeding zone of the assembly and a multi-orifice die. A matrix composition consisting of pre-blended spice(s), herb(s), vegetable and fruit powder(s), food polymer(s), and low molecular weight carbohydrates was metered into the feed port at a feed rate between 100 to 250 g/min of solids. A liquid plasticizer was injected into the feed zone of the extruder assembly by a metering peristaltic pump at 0-50 ml/min. A liquid flavor was injected into the feed zone of the extruder assembly by a metering peristaltic pump at 2-30 g/min, depending on the composition. The heating/cooling jacket temperatures of the extruder assembly were set in the range 170-250° F. After bringing the assembly into a steady-state, the extrudate was die-face cut with a cutter. The uniform particles were collected on a tray and optionally dried and air-cooled.

Alternatively, the strands were collected in a viscoelastic state (not glassy) and then they were optionally dried, cooled to yield a glassy solid, and then milled.

### Analytical Methods

The particle size and shape distribution was characterized with a caliper, by sieve analysis, with Malvern particle size analyzer, and optical microscopy.

A Modulated Differential Scanning calorimeter (MDSC) Q2000 (TA Instruments) was used to determine glass transition parameters and melt transitions. The modulated mode employed a sinusoidal modulation of linearly increasing temperature. The modulation allowed separation and characterization of glass transition as a reversing process. A heating ramp rate of 5° C./min was employed in combination with +/−1° C. modulation amplitude and 60 s period of modulation. The glass transition temperature was determined as a midpoint of the glass transition temperature interval. The heat capacity change (ΔCp, J/(g ° C.)) during the step-like glass transition was also measured. The MDSC tests were run in duplicate.

Water content of the matrix blends and final encapsulation compositions was measured by a Karl-Fisher method.

Total flavor load and surface oil were determined by solvent extraction of a flavor, followed by GC analysis. Total flavor load was measured as volume of flavor per weight of encapsulation composition. Surface oil was measured as weight of flavor extracted from the surface of the particles of encapsulation composition.

The particle density of the particles or the milled extruded strands was measured with a Micromeritics powder pycnometer, model AccuRys 1330 (Micromeritics, Norcross, Ga. 30093), using helium as a filling gas.

### EXAMPLES

### Example 1

A matrix composition which included 98.5% by weight of milled black pepper (black pepper fines, McCormick & Co. product code 774386) and 1.5% of inulin was dry blended and fed at a rate of 200 g/min into the extruder assembly. Deionized water was metered into the feed port at 50 g/min. The jacket temperatures were maintained at 220-250° F. No additional flavor or oil was added. The encapsulation composition was extruded through a 0.086″ multi-orifice die without expansion by puffing and the resulting strands were cooled by a cold airflow. Moisture of the strands was 22.8%. Strands were dried on a tray in a Cabella dehydrator with an air flow at 160° F. for 60 min. The final moisture of the strands was 11.1%. The strands became brittle and were milled using a CoMill mill at 800 rpm with 0125 G screen. The resultant solid was brittle glassy with the glass transition temperature. (Tg) 49.4° C. The particles had 1.403 g/cc true specific gravity.

### Example 2

A matrix composition which included 100% by weight of milled black pepper (black pepper fines, McCormick & Co. product code 774386, 12.2% moisture) was fed at a rate of 200 g/min into the extruder assembly. Deionized water was metered into the feed port at 50 g/min. The jacket temperature of the extruder was maintained at 220-250° F. No additional flavor or oil was added. The encapsulate composition was extruded through a 0.086″ multi-orifice die without puffing and the resulting dense, solid strands were cooled by a cold airflow. Moisture of the strands was measured to be 24.8%. Strands were dried in a Cabella dehydrator with an air flow at 160° F. for 1 h 35 min. The final moisture of the strands was 11.2%. The strands became brittle and were milled using a CoMill mill at 800 rpm with 094 G screen. The resultant solid particles containing 11.2% moisture were brittle glassy with the glass transition temperature (Tg) 47° C. The particles had 1.389 g/cc true specific gravity. The following particles size distribution was determined by sieve analysis: 84.4% by weight of the particles were on USS20 sieve, 4.5% on USS30, 2.9% on USS40, 2.3% on USS50, 1.1% on USS60, and 4.8% on the pan.

### Example 3

A matrix composition which included 100% by weight of milled black pepper (black pepper fines, McCormick & Co. product code 774386, 12.2% moisture) was fed at a rate of 200 g/min into the extruder assembly. Filtered water was metered into the feed port at 50 g/min. The extruder jacket temperature was maintained at 220-250° F. in the mixing, melting, and homogenizing zones, and 220° F. in the cooling part of the assembly. No additional flavor or oil was added. The encapsulation composition was extruded through a 0.075″ multi-orifice die without puffing and die-face cut with a rotating cutter. The resulting dense particles contained 22% moisture and were dried in a Aeromatics fluid bed drier at 110° C. for 10 min. The final moisture of the particles was 10.9%. The resultant solid particles were brittle glassy with the glass transition temperature (Tg) 37.8° C.

### Example 4

A matrix composition which included 100% by weight of garlic powder (McCormick & Co. product code R32570, 12.2% moisture) was fed at a rate of 200 g/min into the 2″ extruder assembly. No additional water was added. No additional flavor or oil was added. The extruder jacket temperature was maintained at 220-250° F. in the mixing, melting, and homogenizing zones, and 190-220° F. in the cooling part of the assembly. The encapsulation composition was extruded through a 0.075″ multi-orifice die without puffing and die-face cut with a rotating cutter. The particles were cooled with a cold air flow. In addition, strands were collected and cooled with the cold air flow. Both the particles and the strands became brittle upon cooling without drying. The strands were milled using a CoMill mill at 800 rpm with 094 G screen. The resultant solid particles were brittle glassy with the glass transition temperature (Tg) 48.4° C. and true specific gravity 1.492 g/cc.

### Example 5

A matrix composition which included 100% by weight of onion powder (McCormick & Co. product code R06517) was fed at a rate of 228 g/min into the 2″ extruder assembly. Water was added at 10 g/min. High oleic sunflower oil was added at 12 g/min. The extruder jacket temperature was maintained at 175-250° F. in the mixing, melting, and homogenizing zones, and 170-190° F. in the cooling part of the assembly. The encapsulation composition was extruded through a 0.08″ multi-orifice die without puffing and die-face cut with a rotating cutter. The particles were cooled with a cold air flow. The particles became glassy upon cooling without drying.

### Example 6

A matrix composition which included 100% by weight of garlic powder was fed at a rate of 228 g/min into the 2″ extruder assembly. Water was added at 10 g/min. Basil flavor (McCormick & Co. code DXD108360009) was added at 2 g/min. The extruder jacket temperature was maintained at 175-250° F. in the mixing, melting, and homogenizing zones, and 170-190° F. in the cooling part of the assembly. The encapsulation composition was extruded through a 0.08″ multi-orifice die without puffing and die-face cut with a rotating cutter. The particles were cooled with a cold air flow. The particles became glassy upon cooling without drying.

Where a numerical limit or range is stated herein, the endpoints are included. Also, all values and subranges within a numerical limit or range are specifically included as if explicitly written out.

Obviously, numerous modifications and variations of the present invention are possible in light of the above teachings It is therefore to be understood that, within the scope of the appended claims, the invention may be practiced otherwise than as specifically described herein.

All patents and other references mentioned above are incorporated in full herein by this reference, the same as if set forth at length.

### Embodiments

1. A solid particulate extrusion encapsulation composition, comprising:

(A) an encapsulate, encapsulated in (B) a solid dense matrix comprising one or more matrix components, and one or more plasticizers;

wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein the encapsulate (A) is present in the extrusion encapsulation composition in an amount of from 0.1% to 20% by weight, based on the total weight of the extrusion encapsulation composition;

wherein said extrusion encapsulation composition is prepared by a process comprising:

(i) mixing the matrix components of the dense matrix (B), the encapsulate (A), and the plasticizer, thereby obtaining a blend;

(ii) in at least one extruder melting the blend, dispersing the encapsulate in the melted blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition, wherein said encapsulate (A) is encapsulated in the glassy matrix (B),

(iv) optionally drying the extruded encapsulation composition, and

(v) further cooling the encapsulation composition.

2. A food product comprising the extrusion encapsulation composition of Embodiment 1.

3. The composition of Embodiment 1, wherein the solid dense matrix further comprises one or more plasticizers in an amount of at least 5% by weight based on the total weight of the extrusion encapsulation composition.

4. The composition of Embodiment 1, wherein the glassy matrix comprises at least one carbohydrate selected from the group consisting of a starch, a modified starch, a gum, a maltodextrin, a sugar, a polyol, a corn syrup solid, a modified cellulose, an inulin or other oligosaccharide, a polydextrose, a cyclodextrin, an organic acid, a salt of an organic acid, and mixtures thereof.

5. The composition of Embodiment 4, wherein the carbohydrate is present in an amount of up 20% by weight based on the total weight of the extrusion encapsulation composition.

6. The composition of Embodiment 1, wherein the matrix (B) comprises less than 30% water before the melting.

7. The composition of Embodiment 1, wherein the matrix mixture further comprises up to 30% of at least one plasticizer before the melting.

8. The composition of Embodiment 1, which has a glass transition temperature in the range from 30° C. to 90° C.

9. The composition of Embodiment 1, wherein said dense matrix (B) comprises 50% to 100% by weight based on the total weight of said dense matrix (B) of at least one selected from the group consisting of a spice, an herb, and mixtures thereof.

10. The composition of Embodiment 1, wherein said dense matrix (B) comprises 70% to 100% by weight based on the total weight of said dense matrix (B) of at least one selected from the group consisting of a spice, an herb, a fruit powder, a vegetable powder, and mixtures thereof.

11. The composition of Embodiment 1, wherein said dense matrix (B) comprises 95% to 100% by weight based on the total weight of said dense matrix (B) of at least one selected from the group consisting of a spice, an herb, a fruit powder, a vegetable powder, and mixtures thereof.

12. The composition of Embodiment 1, wherein said dense matrix (B) comprises 95% to 100% by weight, based on the total weight of said dense matrix (B), of at least one selected from the group consisting of a spice, an herb, and mixtures thereof.

13. The composition of Embodiment 1, wherein said encapsulate (A) is at least one selected from the group consisting of a flavor, a fragrance, a vitamin, a dietary supplement, a medication, a preservative, a color, and a pesticide.

14. The composition of Embodiment 9, wherein said encapsulate (A) is a flavor.

15. The composition of Embodiment 10, wherein said encapsulate (A) is a flavor.

16. The composition of Embodiment 14, wherein said flavor is at least one selected from the group consisting of a natural extract, a natural flavor, an oleoresin, an essential oil, a protein hydrolyzate, a reaction flavor, an artificial flavor, and a compounded flavor.

17. The composition of Embodiment 3, wherein said plasticizer is at least one selected from the group consisting of water, glycerin, propylene glycol, and mixtures thereof.

18. The composition of Embodiment 1, wherein said mixing, melting, dispersion, and cooling are performed in an extruder selected from the group consisting of a single screw extruder, a twin screw extruder, or in a combination of the extruders.

19. The composition of Embodiment 1, wherein said shaping is performed by extruding the viscous dispersion through a die to form strands, and subsequently milling the strands after drying and cooling.

20. The composition of Embodiment 1, wherein said shaping is performed by extruding and die-face cutting the viscous dispersion with a cutter to form particles, and subsequently cooling the particles and optionally drying.

21. A method of making a solid particulate extrusion encapsulation composition, comprising:

(A) an encapsulate, encapsulated in (B) a solid dense matrix comprising one or more matrix components, and one or more plasticizers;

wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein the encapsulate (A) is present in the extrusion encapsulation composition in an amount of from 0.1% to 20% by weight, based on the total weight of the extrusion encapsulation composition;

said method comprising:

(i) mixing the matrix components of the dense matrix (B), the encapsulate (A), and the plasticizer, thereby obtaining a blend;

(ii) in at least one extruder melting the blend, dispersing the encapsulate in the melted blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition, wherein said encapsulate (A) is encapsulated in the dense matrix (B),

(iv) optionally drying the extruded encapsulation composition, and

(v) further cooling the encapsulation composition.

22. The method of Embodiment 21, wherein the matrix components and the encapsulate (A) are mixed to form a dry blend, and the dry blend is melted without adding water or plasticizer.

23. The method of Embodiment 21, further comprising:

drying the extrusion encapsulation composition after the extruding, shaping and cooling.

24. The method of Embodiment 21, wherein after the extruding, shaping and cooling the extrusion encapsulation composition is not dried.

25. The method of Embodiment 21, wherein said solid dense extrusion encapsulation composition is in a glassy state with a glass transition temperature in the range from 30° C. to 90° C.

26. The method of Embodiment 21, wherein the solid dense matrix further comprises one or more plasticizers in an amount of at least 5% by weight based on the total weight of the extrusion encapsulation composition.

27. The method of Embodiment 21, wherein the dense matrix comprises at least one carbohydrate selected from the group consisting of a starch, a modified starch, a gum, a maltodextrin, a sugar, a polyol, a corn syrup solid, a modified cellulose, an inulin or other oligosaccharide, a polydextrose, a cyclodextrin, an organic acid, a salt of an organic acid, and mixtures thereof.

28. The method of Embodiment 27, wherein the carbohydrate is present in an amount of up 20% by weight based on the total weight of the extrusion encapsulation composition.

29. The method of Embodiment 21, wherein the dense matrix (B) comprises less than 30% water before the melting.

30. The method of Embodiment 21, wherein the dense matrix (B) comprises up to 30% of at least one plasticizer before the melting.

31. The method of Embodiment 21, wherein said dense matrix (B) comprises 50% to 100% by weight based on the total weight of said dense matrix (B) of at least one selected from the group consisting of a spice, an herb, and mixtures thereof.

32. The method of Embodiment 21, wherein said dense matrix (B) comprises 70% to 100% by weight based on the total weight of said dense matrix (B) of at least one selected from the group consisting of a spice, an herb, a fruit powder, a vegetable powder, and mixtures thereof.

33. The method of Embodiment 21, wherein said dense matrix (B) comprises 95% to 100% by weight based on the total weight of said dense matrix (B) of at least one selected from the group consisting of a spice, an herb, a fruit powder, a vegetable powder, and mixtures thereof.

34. The method of Embodiment 21, wherein said dense matrix (B) comprises 95% to 100% by weight, based on the total weight of said dense matrix (B), of at least one selected from the group consisting of a spice, an herb, and mixtures thereof.

35. The method of Embodiment 21, wherein said encapsulate (A) is at least one selected from the group consisting of a flavor, a fragrance, a vitamin, a dietary supplement, a medication, a preservative, a color, and a pesticide.

36. The method of Embodiment 31, wherein said encapsulate is a flavor.

37. The method of Embodiment 32, wherein said encapsulate is a flavor.

38. The method of Embodiment 36, wherein said flavor is at least one selected from the group consisting of a natural extract, a natural flavor, an oleoresin, an essential oil, a protein hydrolyzate, an aqueous reaction flavor, an artificial flavor, and a compounded flavor.

39. The composition of Embodiment 26, wherein said plasticizer is at least one selected from the group consisting of water, glycerin, propylene glycol, and mixtures thereof.

40. The method of Embodiment 21, wherein said mixing, melting, dispersion, and cooling are performed in an extruder selected from the group consisting of a single screw extruder, a twin screw extruder, or in a combination of the extruders.

41. The method of Embodiment 21, wherein said shaping is performed by extruding the viscous dispersion through a die to form strands, and subsequently milling the strands after drying and cooling.

42. The method of Embodiment 21, wherein said shaping is performed by extruding and die-face cutting the viscous dispersion with a cutter to form particles, and subsequently cooling the particles and optionally drying.

43. A solid particulate extrusion encapsulation composition, comprising:

(B) a solid dense matrix comprising:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);

wherein said extrusion encapsulation composition is prepared by a process comprising:

(i) mixing the matrix components of the dense matrix (B), and optionally a plasticizer, thereby obtaining a blend;

(ii) in at least one extruder melting the blend to form a viscous dispersion, and optionally cooling the viscous dispersion in the extruder or in a combination of extruders;

(iii) shaping, extruding, and die-face cutting said viscous dispersion, thereby obtaining said extrusion encapsulation composition,

(iv) optionally drying the extruded encapsulation composition, and

(v) further cooling the encapsulation composition, and

wherein the solid particulate extrusion encapsulation composition contains less than 15% water based on the total weight of the glassy extrusion encapsulation composition.

44. A food product comprising the extrusion encapsulation composition of Embodiment 43.

45. The composition of Embodiment 43, wherein the dense matrix further comprises one or more plasticizers in an amount of at least 5% by weight based on the total weight of the extrusion encapsulation composition.

46. The composition of Embodiment 43, wherein the dense matrix comprises at least one carbohydrate selected from the group consisting of a starch, a modified starch, a gum, a maltodextrin, a sugar, a polyol, a corn syrup solid, a modified cellulose, an inulin or other oligosaccharide, a polydextrose, a cyclodextrin, an organic acid, a salt of an organic acid, and mixtures thereof

47. The composition of Embodiment 46, wherein the carbohydrate is present in an amount of up 20% by weight based on the total weight of the extrusion encapsulation composition.

48. The composition of Embodiment 43, wherein the blend comprises less than 30% water before the melting.

49. The composition of Embodiment 43, wherein the blend comprises up to 30% of at least one plasticizer before the melting.

50. The composition of Embodiment 43, which has a glass transition temperature in the range from 30° C. to 90° C.

51. The composition of Embodiment 43, wherein said dense matrix (B) comprises 50% to 100% by weight based on the total weight of said dense matrix (B) of at least one selected from the group consisting of a spice, an herb, and mixtures thereof.

52. The composition of Embodiment 43, wherein said dense matrix (B) comprises 70% to 100% by weight based on the total weight of said dense matrix (B) of at least one selected from the group consisting of a spice, an herb, a fruit powder, a vegetable powder, and mixtures thereof.

53. The composition of Embodiment 43, wherein said dense matrix (B) comprises 95% to 100% by weight based on the total weight of said dense matrix (B) of at least one selected from the group consisting of a spice, an herb, a fruit powder, a vegetable powder, and mixtures thereof.

54. The composition of Embodiment 43, wherein said dense matrix (B) comprises 95% to 100% by weight, based on the total weight of said dense matrix (B), of at least one selected from the group consisting of a spice, an herb, and mixtures thereof

55. The composition of Embodiment 45, wherein said plasticizer is at least one selected from the group consisting of water, glycerin, propylene glycol, and mixtures thereof.

56. The composition of Embodiment 43, wherein said mixing, melting, dispersion, and cooling are performed in an extruder selected from the group consisting of a single screw extruder, a twin screw extruder, or in a combination of the extruders.

57. The composition of Embodiment 43, wherein said shaping is performed by extruding the viscous dispersion through a die to form strands, and subsequently milling the strands after drying and cooling.

58. The composition of Embodiment 43, wherein said shaping is performed by extruding and die-face cutting the viscous dispersion with a cutter to form particles, and subsequently cooling the particles and optionally drying.

59. A method of making a solid particulate extrusion encapsulation composition, comprising:

a solid dense matrix (B) comprising:
(i) at least one of a spice, an herb, a fruit powder, a vegetable powder, and a mixture thereof in an amount of 50 to 100% by weight based on the total weight of said solid dense matrix (B); and
(ii) at least one carbohydrate in an amount of 0 to 50% by weight based on the total weight of said solid dense matrix (B);

said method comprising:
(i) mixing the matrix components of the dense matrix (B) and optionally a plasticizer, thereby obtaining a blend;
(ii) in at least one extruder melting the blend to form a viscous dispersion, and optionally cooling the viscous dispersion in the extruder or in a combination of extruders;
(iii) shaping, extruding, and die-face cutting said viscous dispersion, thereby obtaining said solid particulate encapsulation composition,
(iv) optionally drying the extruded solid particulate encapsulation composition, and
(v) further cooling the solid particulate encapsulation composition,

wherein said particulate extrusion encapsulation composition contains less than 15% water based on the total weight of the particulate extrusion encapsulation composition.

60. The method of Embodiment 59, wherein the matrix components of the dense matrix (B) are melted without adding water or plasticizer.

61. The method of Embodiment 59, further comprising:

drying the extrusion encapsulation composition after the extruding, shaping and cooling.

62. The method of Embodiment 59, wherein after the extruding, shaping and cooling the extrusion encapsulation composition is not dried.

63. The method of Embodiment 59, wherein said extrusion encapsulation composition has a glass transition temperature in the range from 30° C. to 90° C.

64. The method of Embodiment 59, wherein the solid dense matrix further comprises one or more plasticizers in an amount of at least 5% by weight based on the total weight of the extrusion encapsulation composition.

65. The method of Embodiment 59, wherein the solid dense matrix comprises at least one carbohydrate selected from the group consisting of a starch, a modified starch, a gum, a maltodextrin, a sugar, a polyol, a corn syrup solid, a modified cellulose, an inulin or other oligosaccharide, a polydextrose, a cyclodextrin, an organic acid, a salt of an organic acid, and mixtures thereof.

66. The method of Embodiment 65, wherein the carbohydrate is present in an amount of up 20% by weight based on the total weight of the extrusion encapsulation composition.

67. The method of Embodiment 59, wherein the matrix components of the dense matrix (B) comprise less than 30% water before the melting.

68. The method of Embodiment 59, wherein the matrix components of the dense matrix (B) comprise up to 30% of at least one plasticizer before the melting.

69. The method of Embodiment 59, wherein said solid dense matrix (B) comprises 50% to 100% by weight based on the total weight of said solid dense matrix (B) of at least one selected from the group consisting of a spice, an herb, and mixtures thereof.

70. The method of Embodiment 59, wherein said solid dense matrix (B) comprises 70% to 100% by weight based on the total weight of said solid dense matrix (B) of at least one selected from the group consisting of a spice, an herb, a fruit powder, a vegetable powder, and mixtures thereof.

71. The method of Embodiment 59, wherein said solid dense matrix (B) comprises 95% to 100% by weight based on the total weight of said solid dense matrix (B) of at least one selected from the group consisting of a spice, an herb, a fruit powder, a vegetable powder, and mixtures thereof.

72. The method of Embodiment 59, wherein said solid dense matrix (B) comprises 95% to 100% by weight, based on the total weight of said solid dense matrix (B), of at least one selected from the group consisting of a spice, an herb, and mixtures thereof.

1. A solid particulate extrusion encapsulation composition, comprising:
(A) an encapsulate, encapsulated in (B) a solid dense matrix comprising one or more matrix components, and one or more plasticizers;
wherein said solid dense matrix (B) comprises:
(i) at least one of a spice, an herb, a fruit powder, a vegetable powder, and a mixture thereof, in an amount of above 40% and up to 100% by weight based on the total weight of said solid dense matrix (B); and
(ii) at least one carbohydrate or protein in an amount of 0 to 50% by weight based on the total weight of said solid dense matrix (B);
wherein the encapsulate (A) is present in the extrusion encapsulation composition in an amount of from 0.1% to 20% by weight, based on the total weight of the extrusion encapsulation composition;
wherein said extrusion encapsulation composition is prepared by a process comprising:
(i) mixing the matrix components of the dense matrix (B), the encapsulate (A), and the plasticizer, thereby obtaining a blend;
(ii) in at least one extruder melting the blend, dispersing the encapsulate in the melted blend to form a viscous dispersion, and optionally cooling the viscous dispersion in the extruder or in a combination of extruders;
(iii) shaping, extruding, and die-face cutting said viscous dispersion, thereby obtaining said extrusion encapsulation composition, wherein said encapsulate (A) is encapsulated in the glassy matrix (B),
(iv) optionally drying the extruded encapsulation composition, and
(v) further cooling the encapsulation composition.

2. A food product comprising the extrusion encapsulation composition of claim 1.

3. The composition of claim 1, wherein the solid dense matrix further comprises one or more plasticizers in an amount of at least 5% by weight based on the total weight of the extrusion encapsulation composition.

4. The composition of claim 1, wherein the glassy matrix comprises at least one carbohydrate selected from the group consisting of a starch, a modified starch, a gum, a maltodextrin, a sugar, a polyol, a corn syrup solid, a modified cellulose, an inulin or other oligosaccharide, a polydextrose, a cyclodextrin, an organic acid, a salt of an organic acid, and mixtures thereof.

5. The composition of claim 4, wherein the carbohydrate is present in an amount of up 20% by weight based on the total weight of the extrusion encapsulation composition.

6. The composition of claim 1, wherein the matrix (B) comprises less than 30% water before the melting.

7. The composition of claim 1, wherein the matrix mixture further comprises up to 30% of at least one plasticizer before the melting.

8. The composition of claim 1, which has a glass transition temperature in the range from 30° C. to 90° C.

9. The composition of claim 1, wherein said dense matrix (B) comprises 50% to 100% by weight based on the total weight of said dense matrix (B) of at least one selected from the group consisting of a spice, an herb, and mixtures thereof.

10. The composition of claim 1, wherein said dense matrix (B) comprises 70% to 100% by weight based on the total weight of said dense matrix (B) of at least one selected from the group consisting of a spice, an herb, a fruit powder, a vegetable powder, and mixtures thereof.

11. The composition of claim 1, wherein said dense matrix (B) comprises 95% to 100% by weight based on the total weight of said dense matrix (B) of at least one selected from the group consisting of a spice, an herb, a fruit powder, a vegetable powder, and mixtures thereof.

12. The composition of claim 1, wherein said dense matrix (B) comprises 95% to 100% by weight, based on the total weight of said dense matrix (B), of at least one selected from the group consisting of a spice, an herb, and mixtures thereof.

13. The composition of claim 1, wherein said encapsulate (A) is at least one selected from the group consisting of a flavor, a fragrance, a vitamin, a dietary supplement, a medication, a preservative, a color, and a pesticide.

14. The composition of claim 9, wherein said encapsulate (A) is a flavor.

15. The composition of claim 10, wherein said encapsulate (A) is a flavor.

16. The composition of claim 14, wherein said flavor is at least one selected from the group consisting of a natural extract, a natural flavor, an oleoresin, an essential oil, a protein hydrolyzate, a reaction flavor, an artificial flavor, and a compounded flavor.

17. The composition of claim 3, wherein said plasticizer is at least one selected from the group consisting of water, glycerin, propylene glycol, and mixtures thereof.

18. The composition of claim 1, wherein said mixing, melting, dispersion, and cooling are performed in an extruder selected from the group consisting of a single screw extruder, a twin screw extruder, or in a combination of the extruders.

19. The composition of claim 1, wherein said shaping is performed by extruding the viscous dispersion through a die to form strands, and subsequently milling the strands after drying and cooling.

20. The composition of claim 1, wherein said shaping is performed by extruding and die-face cutting the viscous dispersion with a cutter to form particles, and subsequently cooling the particles and optionally drying.
